(19) United States
(12) Patent Application Publication
(10) Pub. No.: US 2026/0261109 A1
(43) Pub. Date: Sep. 3, 2026

(54) RETRACTABLE CHARGING CABLE SYSTEM WITH SERVICEABILITY

(71) Applicant: GM GLOBAL TECHNOLOGY OPERATIONS LLC, Detroit, MI (US)

(72) Inventors: Minseok Jeon, Gimpo-si (KR); Seonjeong Huh, Seoul (KR); Seungjin Jang, Seoul (KR)

(73) Assignee: GM GLOBAL TECHNOLOGY OPERATIONS LLC, Detroit, MI (US)

(21) Appl. No.: 19/068,607

(22) Filed: Mar. 3, 2025

(51) Int. Cl. H02G 11/02; B60R 16/03; H02J 7/70

(52) U.S. Cl. CPC H02G 11/02; B60R 16/03; H02J 7/70

(57) ABSTRACT

A retractable charging cable system provides convenient access to charging and communication with location flexibility. A retractable charging cable system includes a spool that has a drive gear. A driven shaft includes a driven gear engaging the drive gear. A guide is disposed on the driven shaft to translate on the driven shaft when the driven gear is driven by the drive gear. The spool operates to retractably deploy a cable and the guide controls location of the cable along the spool during deployment and retraction.

### INTRODUCTION

The technical field generally relates to cable systems for charging and signal communication, and more particularly relates to a retractable cable system that is convenient and serviceable for applications where stowability and flexibility of use may be desirable.

A number of portable electronic devices may be carried by individuals for use in a variety of locations. A common feature of these devices is that they have an internal battery that needs to be maintained in a charged state for the device to remain operable. In addition, it may be desirable to provide a high-speed communication connection between the devices and another electronic device to which they may be linkable. To ensure the ability to charge devices when needed, a person may carry a cable and/or a backup battery with them when moving from one location to another. Low battery anxiety may arise in circumstances where the battery of a device, such as of a smartphone a person is carrying, is approaching a low battery condition. This condition may be exacerbated when an individual forgets to pack a charging cable.

Many locations where convenient access to a charging cable is desirable are in mobile platforms such as various types of vehicles. Other applications may be stationary, such as buildings and outside venues. Locations may include locations accessible to the public and may also include private places. In addition to accessibility, charging cables are desirably maintained in an operable condition and so are preferably protected when not in use. Because of the frequency of their use, charging cables tend to wear over time and may require replacement.

Accordingly, there is a desire to provide charging cable systems designed and constructed to be stowable and conveniently used in a variety of locations, while doing so in a flexible manner that is tailorable to various applications. There is also a desire to provide ready serviceability, such as in situations where the cable is ready for replacement or exchange. Furthermore, other desirable features and characteristics of the present disclosure will become apparent from the subsequent detailed description and the appended claims, taken in conjunction with the accompanying drawings and the foregoing introduction.

### SUMMARY

A retractable charging cable system provides convenient access to charging and communication with location flexibility. In a number of embodiments, a retractable charging cable system includes a spool that has a drive gear. A driven shaft includes a driven gear engaging the drive gear. A guide is disposed on the driven shaft and operates to translate on the driven shaft when the driven gear is driven by the drive gear. The spool operates to retractably deploy a cable and the guide controls location of the cable along the spool during deployment and retraction.

In additional embodiments, a spring biases the spool to automatically retract the cable to a coiled state on the spool when not in use.

In additional embodiments, a retractor assembly is releasably lockable to lock the cable in place at a desired length and to release to retract the cable.

In additional embodiments, the driven shaft has a guide gear and the guide translates on the guide gear during rotation of the driven shaft to move the guide during the deployment and the retraction to prevent twisting and tangling of the cable.

In additional embodiments, the spool is mounted on a shaft with a notch to break when a force on the cable exceeds a threshold magnitude.

In additional embodiments, the spool is mounted in a retractor assembly and the spool is removable from the retractor assembly to replace the cable.

In additional embodiments, the cable is coupled with a vehicle electric system.

In additional embodiments, the spool is mounted in a retractor assembly that is disposed in an interior vehicle component.

In additional embodiments, the spool is mounted in a retractor assembly. The retractor assembly is disposed in an interior vehicle component. The interior vehicle component includes a door for accessing the retractor assembly. The door has a slot through which the cable is extendable.

In additional embodiments, the spool is included in a retractor assembly and includes a barrel with an open end. A slide is disposed in the barrel. A spring is contained between the barrel and the slide to apply a force to extend the slide from the barrel. The barrel includes a slot and the slide includes a stop disposed in the slot to retain the slide in the barrel and to allow the slide to slide into the barrel to remove the spool from the retractor assembly.

In a number of additional embodiments, a retractable charging cable system includes a retractor assembly that includes a housing. A spool is disposed in the housing and includes a drive gear. The spool is disposed on a drive axis. A driven shaft includes a driven gear engaging the drive gear. The driven shaft is disposed on a driven axis that is spaced from, and parallel to, the drive axis. A guide is disposed on the driven shaft to translate on the driven shaft when the driven gear is driven by the drive gear. The guide defines a guide recess within which the cable fits. The spool operates to retractably deploy a cable. The guide recess operates to guide the cable along the spool during deployment and retraction.

In additional embodiments, a spring is operatively connected between the housing and the spool to bias the spool to automatically retract the cable to a coiled state on the spool when not in use.

In additional embodiments, the retractor assembly is releasably lockable and operates to lock the cable in place at a desired length and to release to retract the cable.

In additional embodiments, the driven shaft includes a guide gear and the guide translates on the guide gear during rotation of the driven shaft to move the guide and the guide recess during the deployment and the retraction so that the cable passes through a moving window to prevent twisting and tangling of the cable.

In additional embodiments, the spool is mounted on a shaft supported on the housing. The shaft has a notch operating to break when a force on the cable exceeds a threshold magnitude to release the spool from the housing.

In additional embodiments, the spool includes a movable slide so that the spool is removable from the retractor assembly to replace the cable.

In additional embodiments, a vehicle electric system includes a controller. The cable is coupled with the vehicle electric system. The vehicle electric system operates to supply power to the cable and to communicate data through the cable. The cable may be a standard universal serial bus cable. The controller operates to monitor a state of the cable and to deliver a signal indicative of the state.

In additional embodiments, the retractor assembly is disposed in a rear seat armrest of a vehicle.

In additional embodiments, the retractor assembly is disposed in an interior vehicle component that includes a door for accessing the retractor assembly. The door has a slot through which the cable is extendable. The spool includes a barrel with an open end. A slide is disposed in the barrel. A spring is contained between the barrel and the slide to apply a force to extend the slide from the barrel. The barrel includes a slot and the slide includes a stop disposed in the slot to retain the slide in the barrel and to allow the slide to slide into the barrel to remove the spool from the retractor assembly through the door.

In a number of other embodiments, a retractable charging cable system for a vehicle includes a retractor assembly that includes a housing mounted in an interior component of the vehicle. A spool is disposed in the housing and includes a drive gear. The spool is disposed on a drive axis. A driven shaft includes a driven gear engaging the drive gear. The driven shaft is disposed on a driven axis that is spaced from and parallel to the drive axis. A guide is disposed on the driven shaft and operates to translate on the driven shaft when the driven gear is driven by the drive gear. The guide defines a guide recess within which the cable fits. The spool operates to retractably deploy a cable, and the guide recess operates to guide the cable along the spool during deployment and retraction. The cable is coupled with a vehicle electric system that operates to supply power to the cable and to communicate data through the cable.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic illustration of an environment in the form of a vehicle that includes a retractable cable system, in accordance with various embodiments;

FIG. 2 is a perspective illustration of the rear set armrest area of the vehicle of FIG. 1 with the retractable cable system, in accordance with various embodiments;

FIG. 3 is a cross sectional illustration taken generally through the line 3-3 in FIG. 2, in accordance with various embodiments;

FIG. 4 is a schematic illustration of the retractor assembly of the retractable cable system of FIGS. 1-3, in accordance with various embodiments;

FIG. 5 is a is a schematic illustration of the connection interface area of the retractor assembly of FIG. 4, in accordance with various embodiments;

FIG. 6 is a perspective view of the retractor assembly of FIG. 4 in an operable state, in accordance with various embodiments;

FIG. 7, is a partial sectional view taken generally through the line 7-7 of FIG. 6, in accordance with various embodiments; and

FIG. 8 is a perspective view of the retractor assembly of FIG. 4 in a state of partial disassembly with a cartridge being removed, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding introduction or the following detailed description.

As used herein, the term module refers to any hardware, software, firmware, electronic control unit or component, processing logic, and/or processor device, individually or in any combination, including without limitation: application specific integrated circuit, an electronic circuit, a processor and memory that executes one or more software or firmware programs, a combinational logic circuit, and/or other suitable components that provide the described functionality. The connecting lines shown in the various figures contained herein are intended to represent example functional relationships and/or physical couplings between the various elements. It should be noted that many alternative or additional functional relationships or physical connections may be present in an embodiment of the present disclosure.

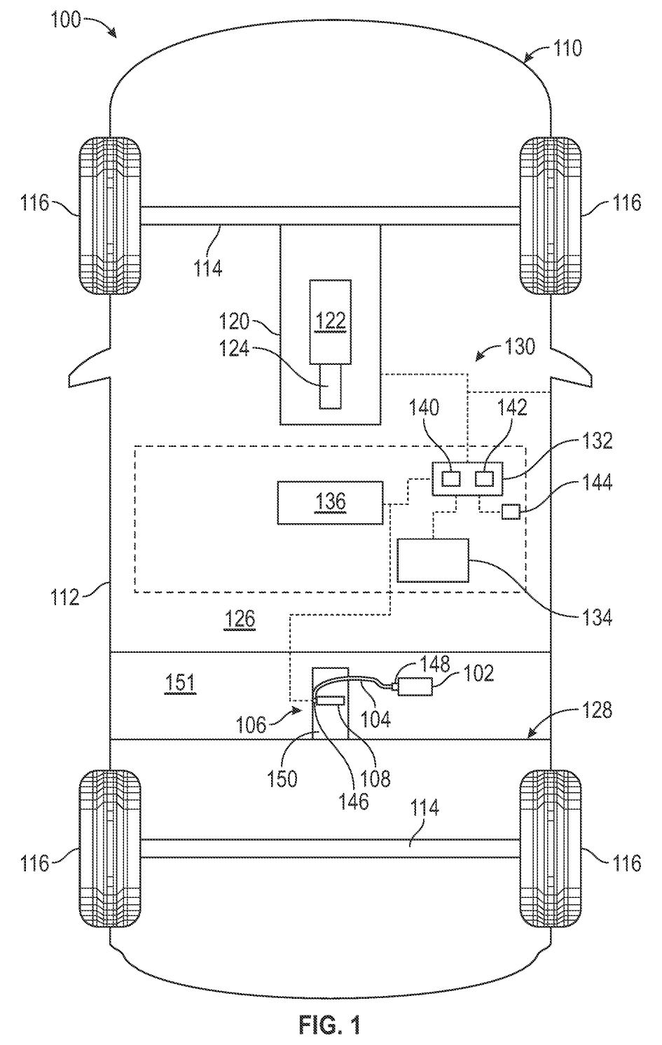

Referring to FIG. 1, illustrated is an environment 100 where a user may carry a device 102 that is chargeable and/or couplable for communication purposes through a cable 104. The cable 104 is part of a retractable cable system 106 with a retractor assembly 108 from which the cable 104 is extendable. In the current embodiment, the environment 100 is a vehicle 110. The vehicle 110 may be any one of a number of different types of land, sea, or air vehicles, and in certain embodiments, may for example, be a passenger automobile of any configuration. In embodiments, the vehicle 110 may be any one of a number of different types of automobiles, such as, for example, a sedan, a wagon, a truck, or a sport utility vehicle, and may be two-wheel drive (i.e., rear-wheel drive or front-wheel drive), four-wheel drive, or all-wheel drive. While the retractable cable system 106 may be described within an embodiment of the vehicle 110, it is not limited to that embodiment but has application in a number of applications including in any environment 100 where use of a charging and/or communication cable 104 is desirable.

As depicted in FIG. 1, the vehicle 110 includes a body 112 arranged on, or integrated with, a chassis which may form a part of the body 112. In general, the body 112 houses the components of the vehicle 110 and serves as an electrical ground for systems on the vehicle 110. The body 112 is connected with front and rear axles 114, such as through chassis elements (not shown). The axles 114 are connected with wheels 116 upon which the vehicle 110 rolls. Any number of the wheels 116 may be coupled with a propulsion system 120 to propel the vehicle 110.

The propulsion system 120 includes a prime mover 122 such as an engine and/or a motor. In the embodiment illustrated in FIG. 1, the propulsion system 120 supplies torque to drive the wheels 116 through a driveline that includes a transmission 124. In various embodiments, the transmission 124 may be configured to couple the front wheels 116 with the propulsion system 120 through the front axle 114. In other embodiments the transmission may be configured to couple the rear wheels 116 through the rear axle 114.

The vehicle 110 includes an interior 126 defined by the body 112 and lined with, or including, a number of interior components 128 that may be functional and/or aesthetic. The interior components 128 may include a dash, seats, armrests, door panels, a headliner, video systems, instruments, trim components, compartments, consoles, floor coverings, trays, holder, etc. The retractable cable system 106 may be based in or on any of the interior components 128 of the vehicle 110. In some embodiments, the retractable cable system 106 may be based in a dedicated interior component 128, such as a dedicated housing.

The retractable cable system 106 is part of an electric system 130 of the vehicle 110. In general, the electric system 130 may include a number of electrically operated, interfacing and/or controlled features of the vehicle 110 and may be embodied as a number of integrated and/or intercommunicating subsystems or separate systems. For purposes of the current disclosure, the electric system 130 includes a controller 132, a battery 134, an infotainment system 136 and the retractable cable system 106 but it will be appreciated that any number of other elements may be included in the electric system 130. The electric system 130 may be interconnected with the propulsion system 120, which may be through a powertrain controller (not shown).

The controller 132 is coupled with the infotainment system 136, the battery 134, the retractable cable system 106, the body 112 as a ground, and the propulsion system 120. As will be appreciated, the controller 132 may be coupled to a number of other devices and systems of the vehicle 110. The controller 132 utilizes data and information and measured values from various sensors (not shown). Generally, the controller 132 is configured to receive inputs from the various devices, including sensors which are configured to generate signals in proportion to various physical input parameters associated with the vehicle 110, subsystems, and other interrelated systems. The controller 132 uses the inputs to effect control actions of the vehicle 110 and its systems.

As illustrated in FIG. 1, the controller 132 is a part of or comprises a computer system. It will be appreciated that the controller 132 may otherwise differ from the example depicted in FIG. 1. The controller 132 may be configured as any number of controllers and/or microcontrollers in communication with each other. For example, separate individual controllers may control aspects of the propulsion system 120 and the infotainment system 136. Accordingly, references to one controller 132 include arrangements with one or more controllers. The controller 132 may accept information from various sources, process that information, and provide control commands based thereon to effect outcomes such as operation of the vehicle 110 and its systems.

In the depicted embodiment, the controller 132 includes a processor 140 and a memory device 142, and is coupled with a storage device 144. The processor 140 performs the computation and control functions of the controller 132, and may comprise any type of processor or multiple processors, single integrated circuits such as a microprocessor, or any suitable number of integrated circuit devices and/or circuit boards working in cooperation to accomplish the functions of a processing unit. During operation, the processor 140 may execute one or more programs and may use data, each of which may be contained within the storage device 144 and as such, the processor 140 controls the general operation of the controller 132.

The memory device 142 may be any type of suitable memory. For example, the memory device 142 may include volatile and nonvolatile storage in read-only memory, random-access memory, and keep-alive memory. In the depicted embodiment, the memory device 142 may store the above-referenced programs along with one or more stored values of the data such as for short-term data access.

The storage device 144 stores the data, such as for long-term data access for use in automatically controlling the vehicle 110 and its systems. The storage device 144 may be any suitable type of storage apparatus, including direct access storage devices such as disk drives and flash systems. The storage device 144 comprises a non-transitory computer readable medium configured to store data, such as on the vehicle 110. In one exemplary embodiment, the storage device 144 comprises a source from which the memory device 142 receives the programs that execute one or more embodiments of one or more processes of the present disclosure. In another exemplary embodiment, the programs may be directly stored in and/or otherwise accessed by the memory device 142. The programs represent executable instructions, used by the controller 132 in processing information and in controlling the vehicle 110 and its systems.

As depicted in FIG. 1, the retractable cable system 106 is connected in the electric system 130. In embodiments, the retractable cable system 106 may include at least parts of the electric system 130. In embodiments, the retractable cable system 106 may be a part of the electric system 130. In embodiments, the retractable cable system 106 may be directly coupled with the infotainment system 136. The cable 104 generally remains coupled with the electric system 130 and when the device 102 is connected to the cable 104 it has access to the power system of the vehicle 110 including the battery 134. Also, when the device 102 is connected to the cable 104 it may interface with the controller 132 and/or the infotainment system 136. Accordingly, the device 102 may be charged and may also exchange data, information, functions and operations with the controller 132 and/or the infotainment system 136, and/or other systems of the vehicle 110. The device 102 may be any apparatus that is powered, chargeable and/or able to communicate data such as a smartphone, tablet, personal computer, radio, light, fan, camera, gaming device, media player, fitness monitor, portable power pack, etc. When a connection is made between the device 102 and the cable 104, the electric system 130 may recognize the device 102 and present options to the user such as through the device 102, the infotainment system 136, or another passenger interface.

The cable 104 may be a standard universal serial bus (USB) cable. In embodiments the cable 104 may be selected for compatibility with a specific type of device or may be a universal cable. For example, the cable 104 may be a USB-C type with compatible connectors 146 and 148. In embodiments, the connector 146 that couples with the electric system 130 of the vehicle 110 may be provided with an adapter set to couple with various types of cables 104. In the field, a user may provide a cable 104 of their choice for use in the retractable cable system 106 and as standards or devices evolve, the cable 104 may be replaced to suit the user’s needs. In embodiments, the controller 132 monitors the cable 104. The controller 132 determines whether the cable 104 is connected to the electric system 130 and may notify the driver, such as through the infotainment system, when the coupling connection is not present. The controller may also determine the state of fitness of the cable 104 and provide a notification if the state is suboptimal or diminished indicating a need to replace the cable 104.

When assembled in the retractable cable system 106, the cable 104 is conveniently presented in the interior 126 of the vehicle 110. The cable 104 may be presented at any interior component 128 and at any passenger or driver position in the vehicle 110. In the current embodiment, the retractor assembly 108, by which the cable 104 is carried, is in the middle armrest 150 of the rear seat 151. As such, the cable 104 is in-reach and readily accessible from both passenger positions of the rear seat 151, including while the passenger is wearing a seatbelt. A separate charging cable need not be carried by the passengers.

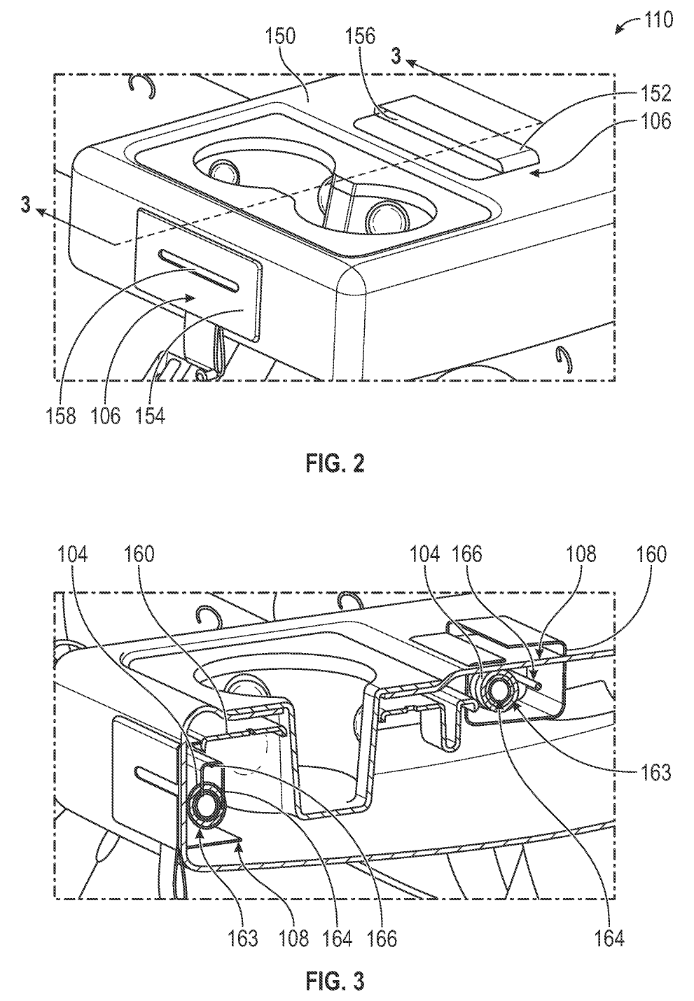

Referring to FIG. 2, the armrest 150 has two alternate locations for the retractable cable system 106. One location is in the front of the lowered armrest 150 and the other is in the top of the lowered armrest 150. In embodiments, two retractable cable systems 106 may be included so that when there are two rear seat passengers each may have a dedicated connection. The retractor assemblies 108 (not visible in FIG. 2) are disposed in the armrest 150 behind panels 152 and 154 that may be openable doors. The panels 152 and 154 have openings 156 and 158, respectively through which to feed the cables 104 from the retractor assemblies 108 to the exterior of the armrest 150. The cables 104 may be completely contained in the armrest 150 when not in use as shown, or may have their connectors disposed on the outside of the openings 156, 158. When disposed inside, the panels 152 and 154 may be opened, the cables 104 fed through the openings 156, 158 and then the panels 152, 154 closed and the cables 104 pulled out to a desired length for use. When stowed, the retractable cable systems 106 present a clean appearance from the outside of the armrest 150.

The disposition of the retractor assemblies 108 inside the armrest 150 is shown in FIG. 3, to which reference is directed. Each retractor assembly 108 includes a housing 160 that is fixed to the armrest 150. The retractor assemblies 108 each include a cable 104 wound on a spool assembly 163 with a follower assembly 166 to maintain the cable 104 in an organized state to avoid tangles, twists, fraying, etc. Both the spool assembly 163 and the follower assembly 166 include rotatable components. The two retractor assemblies 108 may be used and operated independently from one another and both are coupled with the electric system 130.

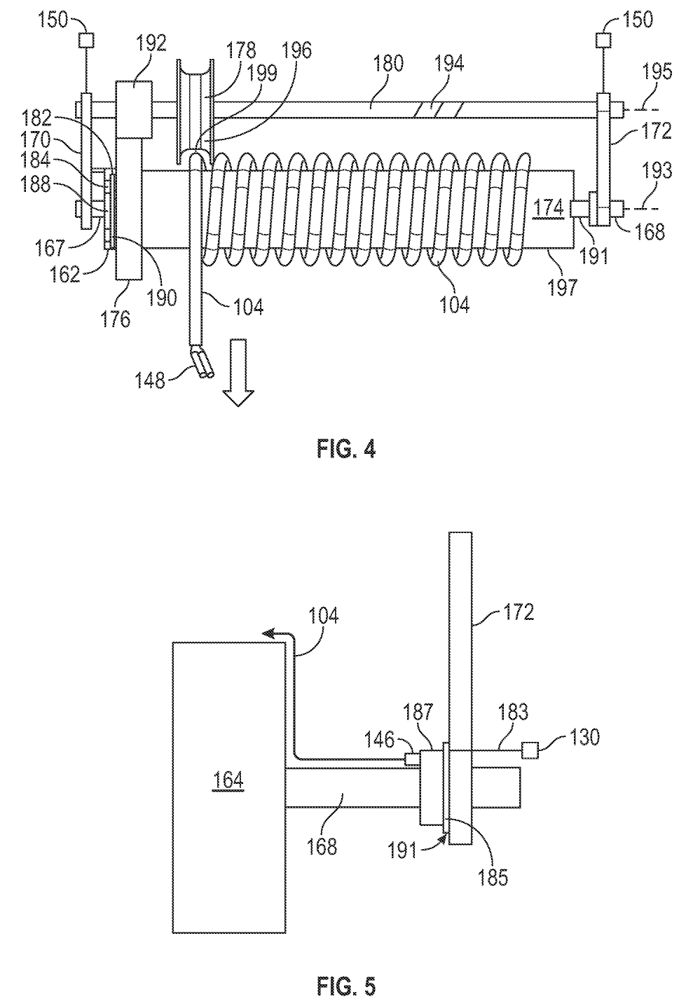

As shown in FIG. 4, the spool assembly 163 includes a spool 164 and shafts 167 and 168, which may be rotatably supported by two brackets 170 and 172, respectively. The brackets 170 and 172 are fixed to the armrest 150. The spool assembly 163 includes a drum 174 on which the cable 104 is wound and a gear 176. The drum 174 and the gear 176 rotate together on the shafts 167 and 168. The spool assembly 163 includes a retractor assembly 162 that latches at various points to hold the cable 104 at selected unwound lengths and is releasable for retraction of the cable 104 onto the spool 164. The follower assembly 166 includes a guide 178 mounted on a shaft 180 and the guide 178 translates along the shaft 180 when the shaft 180 turns.

The retractor assembly 162 is releasably lockable and in a number of embodiments includes a spring 182 to apply a force to rotate the spool 164 to retract the cable 104 and a ratchet assembly 184 to releasably hold the cable 104 at a desired length of deployment. In other embodiments, a different type of retractor assembly 162 may be used. While the internal components of the retractor assembly 162 are not shown un detail, such mechanisms are commercially available and one skilled in the art will understand their operation and design. The spring 182 may be a spiral spring such as a clockspring, a torsion spring, an elastic band, or another type of tensioner. The spring 182 may be wound to increase its tension when the cable 104 is pulled out and may unwind to retract and pull the cable 104 back in when the ratchet assembly 184 is disengaged. The ratchet assembly 184 may include a ratchet gear 188 and a pawl 190. The ratchet gear 188 rotates with the spool 164. The pawl 190 may be pivotably mounted on the bracket 170 and is adapted to engage the ratchet gear 188 to hold the spool 164 against the force of the spring 182 and may be spring loaded toward the ratchet gear 188. The pawl 190 and the ratchet gear 188 structure effectively allow the cable 104 to be withdrawn to the desired length where the retractor assembly 162 is allowed to become locked to maintain the cable 104 in the desired position. When it is desired to retract the cable 104, fully or partially, it is simply necessary to apply a force thereto sufficiently to impart a slight movement to the retractor assembly 162 at which time the force of the spring 182 rotates the spool 164 withdrawing the cable 104 which is wound on the spool 164.

The spool assembly 163 includes the gear 176, which may be any type of gear but in the current embodiment is a helical gear. The follower assembly 166 includes the guide 178 mounted on the shaft 180 and a gear 192 that has helical teeth that are engaged with the teeth of the gear 176 to rotate in concert therewith. Accordingly, when the cable 104 is pulled out the spool 164 rotates on a drive axis 193 and the gear 176 acts as a drive gear. The gear 176 drives the gear 192 as a driven gear rotating the shaft 180 as a driven shaft on a driven axis 195.

Referring to FIG. 5, because the spool 164 rotates and the cable 104 is coupled with the electric system 130, provision may be made for a rotating connection. In an embodiment for purposes of an example, a USB slip ring 191 may be included. The USB slip ring 191 may be designed to transmit signals according to standard protocols through a rotating interface. The USB slip ring 191 rotatably connects the cable 104 with a fixed connection to transmit power and data. With the USB slip ring 191 the connection always remains relaxed and free of twisting avoiding stress and wear on the cable 104. The cable 104 may be a standard USB cable with the connector 146 that couples with a rotating port 187. The USB slip ring 191 includes a flange 185 fixed to the bracket 172 with a fixed conductor 183 coupled with the electric system 130. The USB slip ring 191 includes internal slip rings that maintain contact between the rotating port 187 and the conductor 183. Accordingly, the cable 104 may remain coupled through the connector 146 during deployment and retraction and may be unplugged when desired.

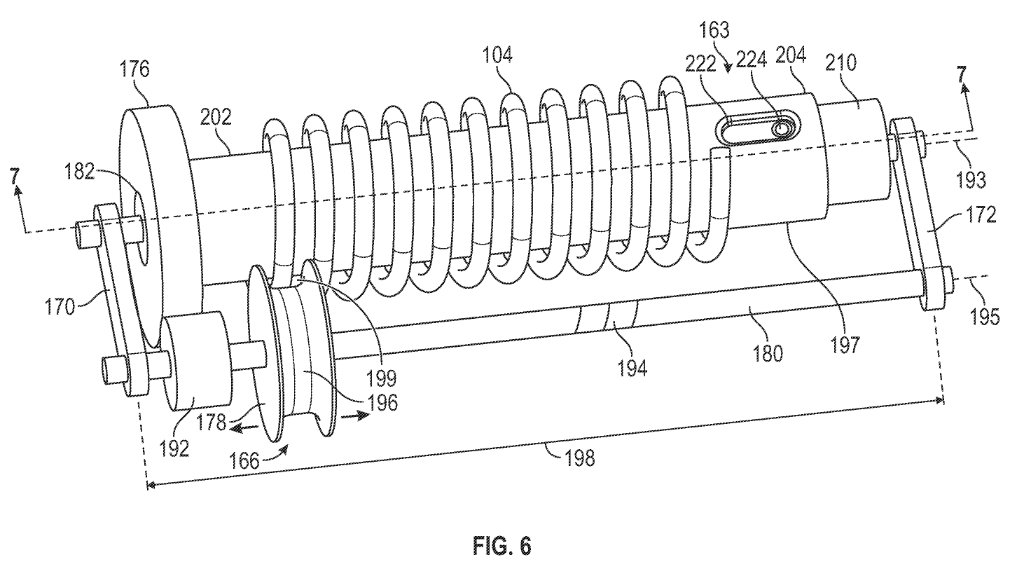

Referring to FIG. 6 along with FIG. 4, the shaft 180 has threads or teeth 194 and the guide 178 has internal threads or teeth that engage the teeth 194. For example, the shaft 180 may be a type of worm gear and the teeth 194 may be worm threads. The guide 178 has internal threads that engage the shaft 180 so that the guide 178 translates along the length of the spool 164 when the shaft 180 turns in concert with the spool 164. The guide 178 includes a groove around its outer periphery referred to as guide recess 196. The guide recess 196 is an area formed by the shape of the guide 178 within which the cable 104 fits and together with the outer periphery 197 of the spool 164 defines the location of the point of the cable 104 entering or exiting the spool 164 during deployment and retraction. The shape of the guide recess 196 and its location relative to the spool 164 define a window 199 through which the cable 104 must pass during deployment and retraction. A stop 198 keeps the guide from rotating so that it translates along the shaft 180 when it turns. The stop 198 may be a bar fixed to the brackets 170 and 172.

When the spring 182 causes the spool 164 to rotate to retract the cable 104, the guide 178 translates spreading the cable 104 along the spool 164 as the cable 104 passes through the moving window 199. The cable 104 is wound on the spool 164 in a spiral shape preventing tangling. When the cable 104 is pulled out, the guide 178 translates in an opposite direction and the cable 104 is guided as it passes through the moving window 199 and feeds off the spool 164.

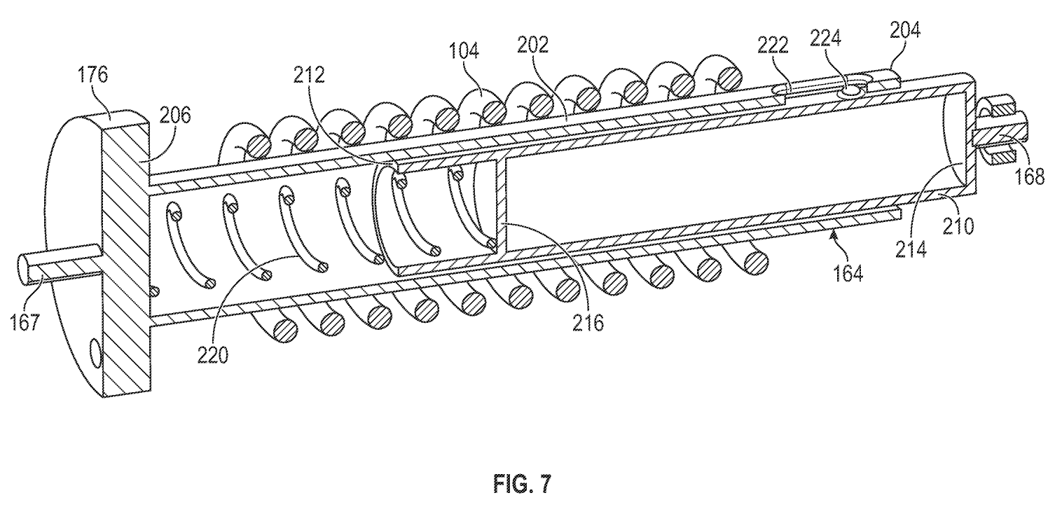

Referring to FIG. 7 along with FIG. 6, the spool 164 is a type of a cartridge that is removeable from the retractor assembly 108 for replacement and also for replacement of the cable 104. The spool 164 includes a barrel 202 in the shape of a hollow cylinder with an open end 204 and a blind end 206. The spool 164 includes a slide 210 that has a hollow cylindrical shape and that also has an open end 212 and a blind end 214. A wall 216 extends across the inside of the slide 210 closer to the open end 212 than to the blind end 214. The slide 210 is received into the barrel 202, open end 212 first. A spring 220, which is a coil type spring, is compressed between the blind end 206 of the barrel 202 and the wall 216 of the slide 210. The spring 220 applies a force to push the slide 210 out of the open end 204 of the barrel 202. The barrel 202 includes a slot 222 and the slide 210 includes a stop 224 disposed in the slot 222 to maintain the slide 210 in the barrel 202.

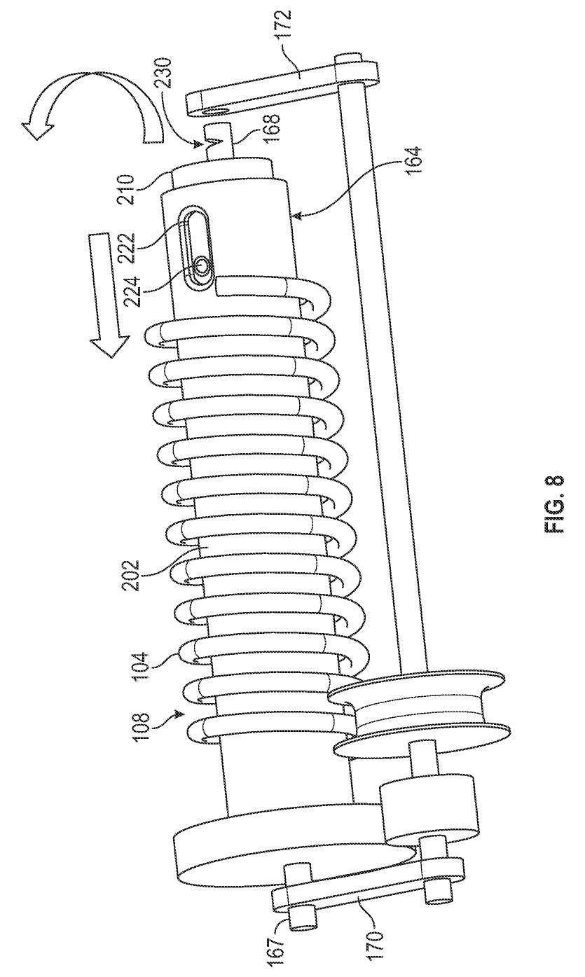

As shown in FIG. 8, to remove the spool 164 from the retractor assembly 108, first the slide 210 is pushed into the barrel 202. The stop 224 moves in the slot 222 and the spring 220 is compressed. This allows the shaft 168 to be removed from the bracket 172 which frees the end of the spool 164. The spool 164 may then be tilted on the shaft 167, the cable 104 unplugged, and the spool 164 may be removed from the retractor assembly 108. The cable 104 may be removed from the spool 164 and replaced by a new cable 104. The spool 164 may then be reassembled into the retractor assembly 108.

As shown in FIG. 8, the shaft 168 has a notch 230 creating a weakened point in the shaft 168. In operation of the retractor assembly 108, when the cable 104 extended out a force on the cable 104 above a threshold will break the shaft 168 at the notch 230 and allow the cable 104 to pull free from the spool 164, such as in case the cable 104 is tangled on an occupant. In the event the shaft 168 is broken, the entire spool 164 may be replaced with a new part.

Accordingly, a retractable cable system for use with device USB cables provides a conveniently accessed and used charging an/or communication connection. The system integrates a retractable charging cable into any environment including in a vehicle at various locations. For deployment, a mechanism includes a drive gear that transmits torque to a driven gear to drive a shaft and to translate a guide to provide anti-twist and anti-tangle operation in both extension and retraction. A spring provides torsion to retract the cable when not in use, and a latching mechanism allows the passenger to extend the cable to the desired length. A mechanical anti-twist guide is provided in a compact low-profile housing. Aging or damaged cables may be easily replaced providing serviceability.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A retractable charging cable system, comprising:
a spool including a drive gear;
a driven shaft including a driven gear engaging the drive gear; and
a guide disposed on the driven shaft and configured to translate on the driven shaft when the driven gear is driven by the drive gear,
wherein the spool is configured to retractably deploy a cable, and the guide is configured to guide the cable along the spool during deployment and retraction.

2. The retractable charging cable system of claim 1, comprising a spring that biases the spool to automatically retract the cable to a coiled state on the spool when not in use.

3. The retractable charging cable system of claim 1, comprising a retractor assembly that is releasably lockable and configured to lock the cable in place at a desired length and to release to retract the cable.

4. The retractable charging cable system of claim 1, wherein the driven shaft comprises a guide gear and wherein the guide translates on the guide gear during rotation of the driven shaft to move the guide during the deployment and the retraction to prevent twisting and tangling of the cable.

5. The retractable charging cable system of claim 1, wherein the spool is mounted on a shaft with a notch configured to break when a force on the cable exceeds a threshold magnitude.

6. The retractable charging cable system of claim 1, wherein the spool is mounted in a retractor assembly, and wherein the spool is removable from the retractor assembly to replace the cable.

7. The retractable charging cable system of claim 1, comprising a vehicle electric system, wherein the cable is coupled with the vehicle electric system.

8. The retractable charging cable system of claim 1, wherein the spool is mounted in a retractor assembly, wherein the retractor assembly is disposed in an interior vehicle component.

9. The retractable charging cable system of claim 1, wherein:
the spool is mounted in a retractor assembly,
the retractor assembly is disposed in an interior vehicle component,
the interior vehicle component includes a door for accessing the retractor assembly, and
the door has a slot through which the cable is extendable.

10. The retractable charging cable system of claim 1, wherein:
the spool is included in a retractor assembly,
the spool includes a barrel with an open end,
a slide is disposed in the barrel,
a spring is contained between the barrel and the slide to apply a force to extend the slide from the barrel,
the barrel includes a slot, and
the slide includes a stop disposed in the slot and configured to retain the slide in the barrel and to allow the slide to slide into the barrel to remove the spool from the retractor assembly.

11. A retractable charging cable system, comprising:
a retractor assembly that includes a housing;
a spool disposed in the housing, the spool including a drive gear and disposed on a drive axis;
a driven shaft including a driven gear engaging the drive gear, wherein the driven shaft is disposed on a driven axis that is spaced from and parallel to the drive axis; and
a guide disposed on the driven shaft and configured to translate on the driven shaft when the driven gear is driven by the drive gear, wherein the guide defines a guide recess within which the cable fits,
wherein the spool is configured to retractably deploy a cable, and the guide recess is configured to guide the cable along the spool during deployment and retraction.

12. The retractable charging cable system of claim 11, comprising a spring operatively connected between the housing and the spool, the spring configured to bias the spool to automatically retract the cable to a coiled state on the spool when not in use.

13. The retractable charging cable system of claim 11, wherein the retractor assembly is releasably lockable and configured to lock the cable in place at a desired length and to release to retract the cable.

14. The retractable charging cable system of claim 11, wherein the driven shaft comprises a guide gear and wherein the guide translates on the guide gear during rotation of the driven shaft to move the guide and the guide recess during the deployment and the retraction so that the cable passes through a moving window to prevent twisting and tangling of the cable.

15. The retractable charging cable system of claim 11, wherein the spool is mounted on a shaft supported on the housing, wherein the shaft has a notch configured to break when a force on the cable exceeds a threshold magnitude to release the spool from the housing.

16. The retractable charging cable system of claim 11, wherein the spool includes a movable slide so that the spool is removable from the retractor assembly to replace the cable.

17. The retractable charging cable system of claim 11, comprising a vehicle electric system including a controller, wherein the cable is coupled with the vehicle electric system, wherein the vehicle electric system is configured to supply power to the cable and to communicate data through the cable, wherein the cable comprises a standard universal serial bus cable, wherein the controller is configured to monitor a state of the cable and to deliver a signal indicative of the state.

18. The retractable charging cable system of claim 11, wherein the retractor assembly is disposed in a rear seat armrest of a vehicle.

19. The retractable charging cable system of claim 11, wherein:
the retractor assembly is disposed in an interior vehicle component,
the interior vehicle component includes a door for accessing the retractor assembly,
the door has a slot through which the cable is extendable,
the spool includes a barrel with an open end,
a slide is disposed in the barrel,
a spring is contained between the barrel and the slide to apply a force to extend the slide from the barrel,
the barrel includes a slot, and
the slide includes a stop disposed in the slot and configured to retain the slide in the barrel and to allow the slide to slide into the barrel to remove the spool from the retractor assembly through the door.

20. A retractable charging cable system for a vehicle, comprising:
a retractor assembly that includes a housing mounted in an interior component of the vehicle;
a spool disposed in the housing, the spool including a drive gear and disposed on a drive axis;
a driven shaft including a driven gear engaging the drive gear, wherein the driven shaft is disposed on a driven axis that is spaced from and parallel to the drive axis;
a guide disposed on the driven shaft and configured to translate on the driven shaft when the driven gear is driven by the drive gear, wherein the guide defines a guide recess within which the cable fits, wherein the spool is configured to retractably deploy a cable, and the guide recess is configured to guide the cable along the spool during deployment and retraction; and
a vehicle electric system, wherein the cable is coupled with the vehicle electric system, wherein the vehicle electric system is configured to supply power to the cable and to communicate data through the cable.
